(19) United States
(12) Patent Application Publication
(10) Pub. No.: US 2015/0109634 A1
(43) Pub. Date: Apr. 23, 2015

(54) IMAGE FORMING APPARATUS, SYSTEM, AND METHOD FOR FORMING IMAGE

(71) Applicant: TOSHIBA TEC KABUSHIKI KAISHA, Tokyo (JP)

(72) Inventors: Masami TAKAHATA, Setagaya Tokyo (JP); Mika HIRAMA, Kokubunji Tokyo (JP); Naoki WATANABE, Adachi Tokyo (JP); Tomonori IKUMI, Numazu Shizuoka (JP); Akihiko FUJIWARA, Kawasaki Kanagawa (JP)

(21) Appl. No.: 14/520,590

(22) Filed: Oct. 22, 2014

(30) Foreign Application Priority Data
Oct. 23, 2013 (JP) 2013-220458

(51) Int. Cl. H04N 1/00; H04N 1/387

(52) U.S. Cl. CPC H04N 1/00411; H04N 1/387; H04N 1/00485; H04N 1/00856; H04N 2201/0094
USPC 358/1.14; 358/1.15

(57) ABSTRACT

An image forming apparatus comprising a main body housing an image forming unit, and a control panel mounted on the main body and including a display unit and an operation unit, the display unit being configured to display a document template and the operation unit being configured to receive a user input related to an image to be added to the document template. The image forming unit is configured to form an image including the document template and the image added to the document template.

### CROSS-REFERENCE TO RELATED APPLICATION

This application is based upon and claims the benefit of priority from Japanese Patent Application No. 2013-220458, filed Oct. 23, 2013, the entire contents of which are incorporated herein by reference.

### FIELD

Embodiments described herein relate generally to an image forming apparatus, system, and method for forming an image using the image forming apparatus.

### BACKGROUND

One type of an image forming apparatus prints an advertisement image or a predetermined image on a sheet together with an image that a user wants to print out. Another type of an image forming apparatus performs user authentication before printing.

### DESCRIPTION OF THE DRAWINGS

FIG. 1 illustrates an example of a printing system according to an embodiment.

FIG. 2 is a block diagram of the printing system according to the embodiment, specifying components of a print server and an MFP.

FIG. 3 is a block diagram of the printing system according to the embodiment, specifying components of an integration server.

FIG. 4 is a flow chart of operations carried out by the printing system according to the first embodiment.

FIG. 5 illustrates an example of a menu screen.

FIG. 6 illustrates an example of a category selection screen.

FIG. 7 illustrates an example of a selection screen of a layout content.

FIG. 8 illustrates an example of a selected layout content.

FIGS. 9A and 9B illustrates examples of a unit that acquires input information.

FIG. 10 illustrates a display example of an integrated content image.

FIG. 11 illustrates operations carried out by the print server and the integration server during an integration process.

FIG. 12 illustrates an example of a data table in which a layout content ID and setting information are associated with each other.

FIG. 13 illustrates the position of input information.

FIG. 14 illustrates an example of a data table in which user information is associated with a user ID.

FIG. 15 is a flow chart of operations when an input process is controlled according to a user's class (authority).

FIG. 16 is a flow chart of operations carried out by a printing system according to a second embodiment.

FIG. 17 illustrates an example of an integrated image according to the second embodiment.

FIG. 18 illustrates operations carried out by the print server, the integration server, and the authentication server during the integration process according to the second embodiment.

### DETAILED DESCRIPTION

In on-demand printing in which printing of a small number of copies, for example, printing of business cards or printing of price tags displayed within a store, is performed in a short time, an easy printing with a simple operation is desired.

Embodiments provide a technique that enables easy printing of user information or information input by the user on a predetermined form.

In general, according to one embodiment, an image forming apparatus comprising a main body housing an image forming unit, and a control panel mounted on the main body and including a display unit and an operation unit, the display unit being configured to display a document template and the operation unit being configured to receive a user input related to an image to be added to the document template. The image forming unit is configured to form an image including the document template and the image added to the document template.

A printing system according to an embodiment performs on-demand printing by integrating specific information of a user using the system or information which is manually input by a user with a selected template image. Hereinafter, the system according to the embodiment will be described with reference to the accompanying drawings. The printing system to be described below is a system that includes a multi-function peripheral (MFP) and a plurality of servers (computers), and is an example of being applied to a retail store.

In a first embodiment, as an example, a price tag for a store is generated. In a second embodiment, as an example, business cards are generated. In the following embodiments, information to be added to a template image, such as user's specific information and information input by a user, will be referred to as “additional data”. In addition, the template image will be referred to as “layout content” or simply “content”.

### First Embodiment

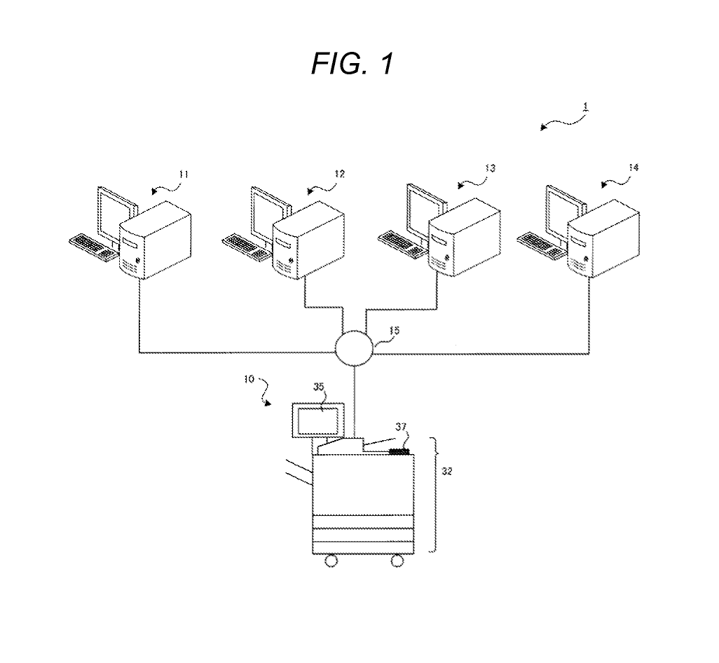

FIG. 1 is a diagram illustrating a configuration example of a printing system according to an embodiment. A printing system 1 includes an MFP 10, a print server 11, a content server 12, an integration server 13, and an authentication server 14. These devices may perform data transmission and reception therebetween through a network 15. Meanwhile, the printing system 1 may be separated from the content server 12 and the authentication server 14.

The MFP 10 is a multifunction machine having a plurality of functions such as a print function, a scan function, and a FAX function. The MFP 10 prints an image obtained by integrating additional data with a layout content (hereinafter, an integrated image) and registers contents using a scan function. A user may select contents and print an integrated image by operating a control panel 35 of the MFP 10. The control panel 35 receives input information from the user and displays a preview of the integrated image. In addition, the MFP 10 includes an image forming unit 32 that forms an image on a sheet, and a non-contact communication unit 37 that reads a card for authentication in a non-contact manner. The non-contact communication unit 37 includes, for example, a card reader device. The MFP 10 has a web browser function, and thus receives a user's operation on the control panel 35 and performs a display by using the web browser function.

A program for performing an on-demand printing of a content selected on the control panel 35 of the MFP 10 is installed in advance into the print server 11. It is possible to perform the on-demand printing and to register and manage contents by using the program. In addition, the print server 11 has a database (hereinafter, DB) that stores contents for performing the on-demand printing and information related to the contents, and thus it is possible to register contents obtained from a client computer or image scanning by the MFP 10. In addition, the print server 11 has a web server function, and thus provides a service of the printing system 1 to a user in accordance with an instruction from the web browser introduced into the MFP 10.

The content server 12 has a DB that stores contents for performing the on-demand printing and the information related to the contents. In this example, a DB that stores the contents is provided not only in the print server 11 but also in the content server 12 outside the print server 11, and thus it is possible to use both DBs. Accordingly, the contents may be stored in any device as long as the contents may have access to the print server 11 through the network 15.

The integration server 13 is a server that performs an integration process of the selected layout content and the additional data. In this example, it is assumed that the layout content is stored also in the integration server 13, but the layout content may be acquired from the print server 11 or the content server 12 as necessary.

The authentication server 14 is a server that performs user authentication before providing a service of the on-demand printing. In this embodiment, the user authentication is performed with the non-contact communication unit 37 on the MFP 10 and a card. The authentication server 14 receives identification information obtained from the card by the non-contact communication unit 37 and performs an authentication process. In addition, the authentication server 14 stores information about a user, such as a rank and name of the user, in correlation with the identification information of the user. The user information may be stored in a device other than the authentication server 14 within the printing system 1 or an external device of the printing system 1.

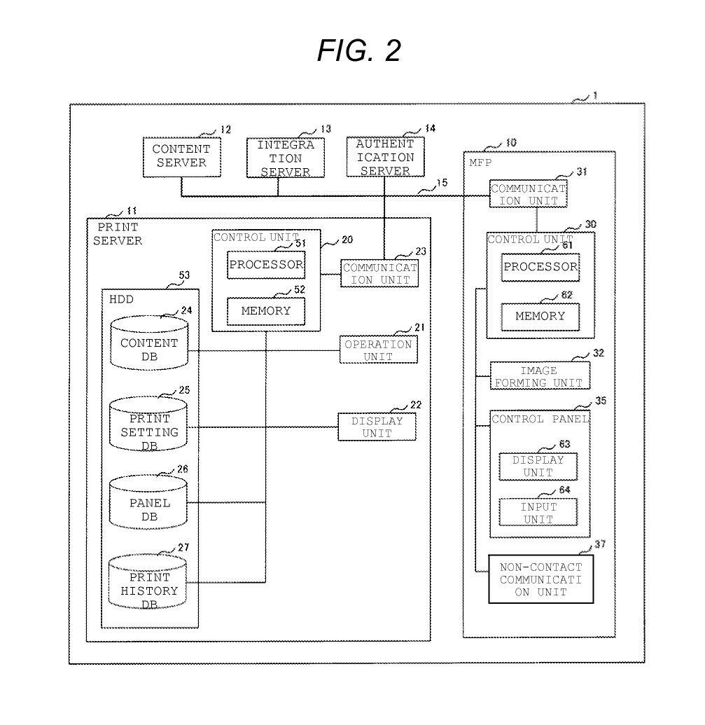

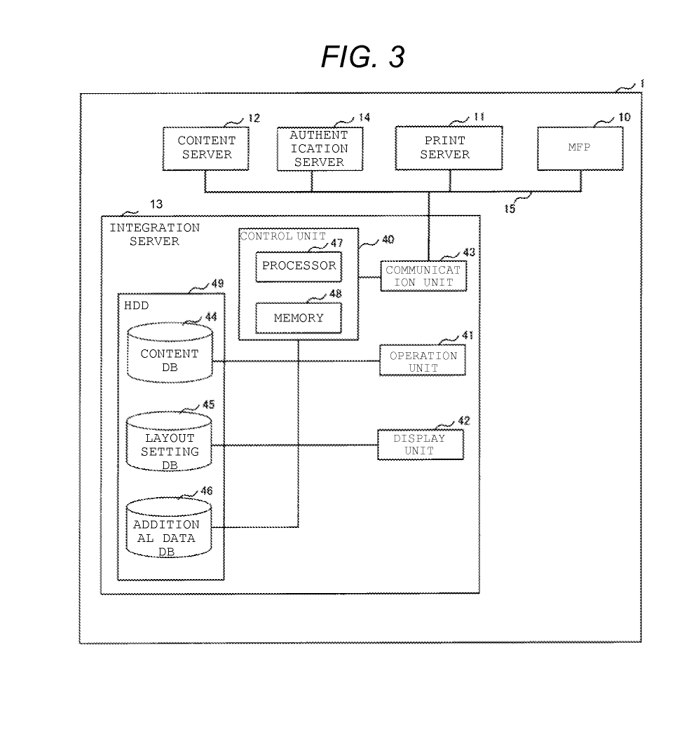

FIGS. 2 and 3 are block diagrams illustrating a system configuration of the printing system according to an embodiment. First, the configuration of the print server 11 will be described with reference to FIG. 2. The control unit 20 includes a processor 51 which is an arithmetic processing unit such as a central processing unit (CPU), and a memory 52 which is a volatile main storage device. The control unit 20 controls hardware within the print server 11 by performing an arithmetic operation on a program, and performs a content management.

The operation unit 21 includes hardware such as a keyboard and a mouse, and receives an input from the user. The display unit 22 includes a monitor, and displays an operation state, an image, and the like. The user can perform maintenance of the print server 11 using these input and output units.

The communication unit 23 includes a network interface card for communicating with external servers (the content server 12, the integration server 13, and the authentication server 14) and an external device (MFP 10). A hard disk drive (HDD) 53 is an auxiliary storage device that stores data in a non-volatile manner. A print on-demand application and a web server program, which are executed by the control unit 20, are preinstalled thereinto. In addition, a plurality of databases are introduced in advance in the HDD 53. The content DB 24 stores a layout content for the on-demand printing in correlation with an identification (ID). Actually, the layout content is stored as an image file in the HDD 53, and a file name thereof is stored in the content DB 24 in association with the ID. A print setting DB 25 stores setting information used when an integrated image is printed. A panel DB 26 stores a panel image data of a print on-demand application and image data for a user interface. A print history DB 27 stores print history information such as print logs for individual contents.

Next, the configuration of the MFP 10 will be described. The control unit 30 controls printing, scanning, display and operation of an application, and the like by performing an arithmetic operation of the preinstalled application. The control unit 30 includes a processor 61, which is an arithmetic processing unit, and a memory 62 that includes a volatile storage device or a nonvolatile storage device.

The communication unit 31 communicates with external servers (the print server 11, the content server 12, the integration server 13, and the authentication server 14) and external devices.

The image forming unit 32 includes a unit that reads a document sheet or a unit that forms an image on a sheet. The image forming unit 32 includes a scanner that scans a document sheet, color cartridges that accommodate color toners, and a process unit that transfers an image onto a sheet and performs thermal fixing thereon. Units of the related art may be adopted as the above-described units.

The control panel 35 is a unit for performing an operation instructed by a user and notification to a user, and includes a display unit 63, which is a liquid crystal panel, and an input unit 64, which is a touch panel or a keyboard. The non-contact communication unit 37 reads the identification information from an IC card carried by the user, in a non-contact manner. The non-contact communication unit 37 may control communication with an external non-contact communication device.

The configuration of the integration server 13 will be described with reference to FIG. 3. The control unit 40 includes a processor 47 and a memory 48, and performs a process of integrating the additional data with the layout content. The operation unit 41 and the display unit 42 are a keyboard and a monitor, respectively, and are used at the time of the maintenance of the integration server 13, and the like. The communication unit 43 communicates with the external servers (the print server 11, the content server 12, and the authentication server 14) and an external device (MFP 10). An application, which is executed by the control unit 40, is preinstalled in an HDD 49, and various DBs are introduced in advance into the HDD 49. A content DB 44 stores the layout content for the on-demand printing, which is the same layout content as that stored in the content DB 24 of the print server 11. A layout setting DB 45 stores layout information for integrating the content with the additional data. An additional data DB 46 stores the additional data, such as character data, which is set in advance.

The content server 12 and the authentication server 14 have the configuration of a conventional computer. In addition, the functions of the content server 12 and the authentication server 14 may be included within the printing system 1, or may be replaced with a server outside the system. In addition, the non-contact communication unit 37 is included in the MFP 10 in this embodiment. However, the non-contact communication unit 37 may be included in the print server 11 or may be included in another server or device connected to the authentication server 14.

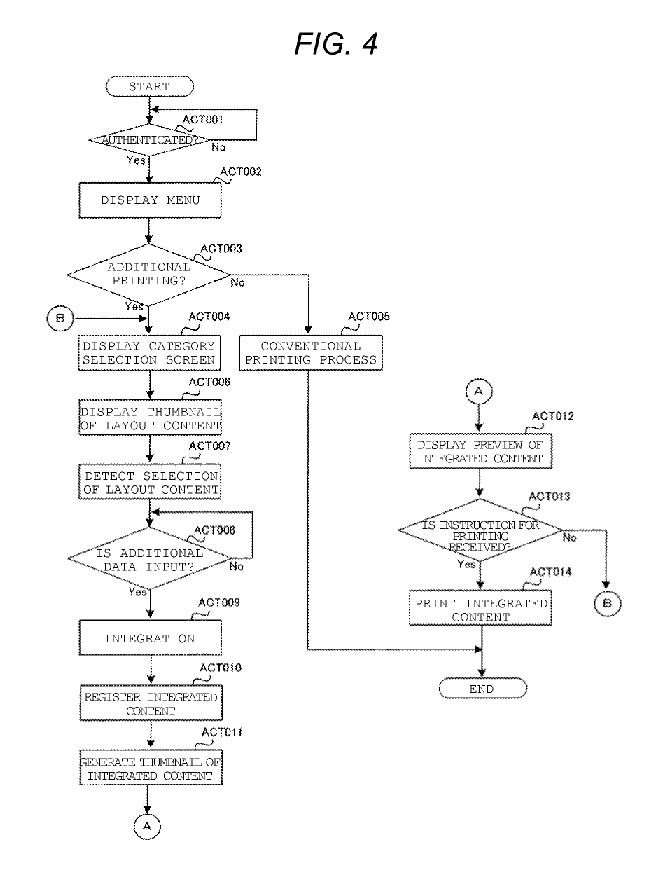

FIG. 4 is a flow chart illustrating an example of operations of a printing system 1 according to a first embodiment. Here, as an example, a price tag is printed. First, the printing system 1 determines whether or not the user is authenticated (ACT001). This process will be described below. The non-contact communication unit 37 included in the MFP 10 reads out identification information of the user from an IC card carried by the user. The read-out identification information is temporarily transmitted to the print server 11, and is then transmitted to the authentication server 14. The authentication server 14 determines success or failure of the authentication. The control unit 20 of the print server 11, which receives the result of the success or failure of the authentication, determines whether to proceed to the next operation, that is, whether to transmit the next screen image to the MFP 10, based on the result. The operation of ACT001 is repeatedly performed until the user is properly authenticated (ACT001, No). In addition, this authentication process may be directly performed between the MFP 10 and the authentication server 14 without the print server 11.

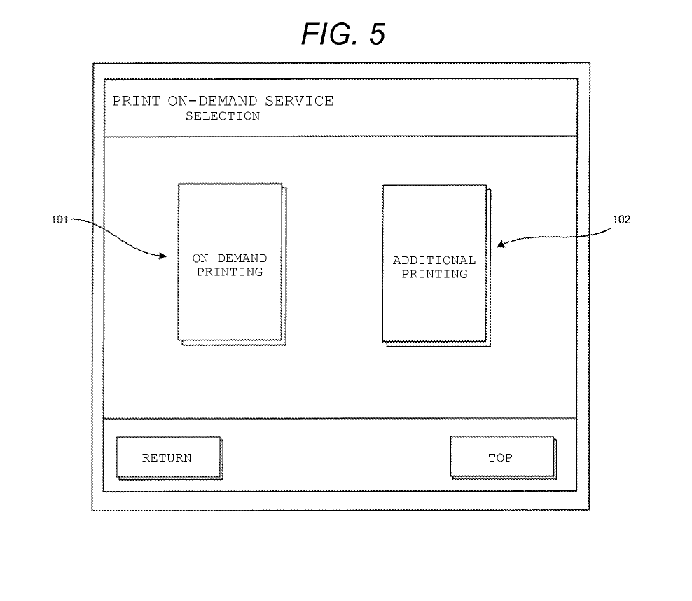

When the user is properly authenticated (ACT001, Yes), the control panel 35 displays a menu screen in response to an instruction from the control unit 30 (ACT002). FIG. 5 illustrates an example of the menu screen. In addition, a display image and layout information for a display, which are displayed on the control panel 35, are stored in advance in the panel DB 26 of the print server 11, and the control unit 30 of the MFP 10 acquires the data through a communication unit 31, when necessary, and causes the control panel 35 to display the data by using a function of a web browser. A user selects a mode on the screen in FIG. 5. In this example, in addition to a conventional printing mode (on-demand printing), an additional printing mode is provided. The control unit 30 determines which one of a button 101 and a button 102 is selected (ACT003).

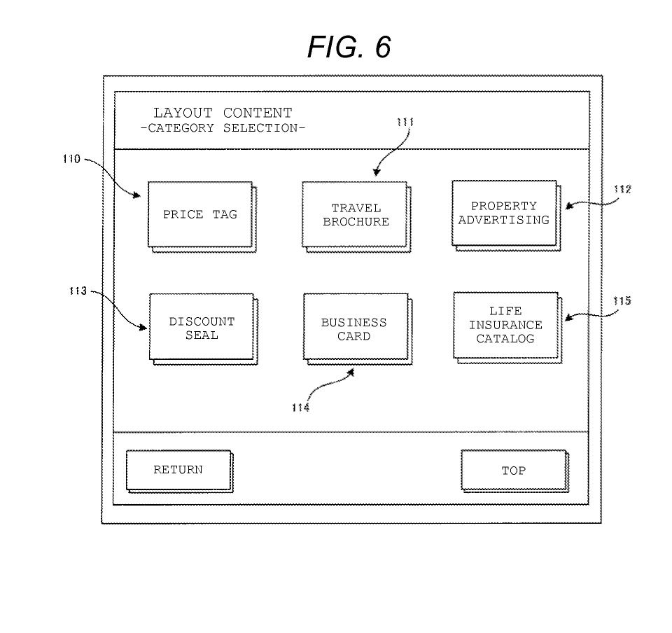

When the button 101 is selected (ACT003, No), the conventional printing mode is executed (ACT005), and the process is terminated at the same time as the completion of the process. When the button 102 is selected (ACT003, Yes), the control panel 35 displays a screen for selecting a print category in response to an instruction of the control unit 30 (ACT004). Here, a screen illustrated in FIG. 6 is displayed on the control panel 35. It is assumed that the printing system 1 of this example may create a price tag, a travel brochure, an advertising of a property such as a house, a discount seal, a name card, and a life insurance catalog. The control unit 30 of the MFP 10 proceeds to the creation of various printed matters by detecting the selection of one of buttons 110 to 115. Here, it is assumed that the button 110 for a label of a price tag is selected.

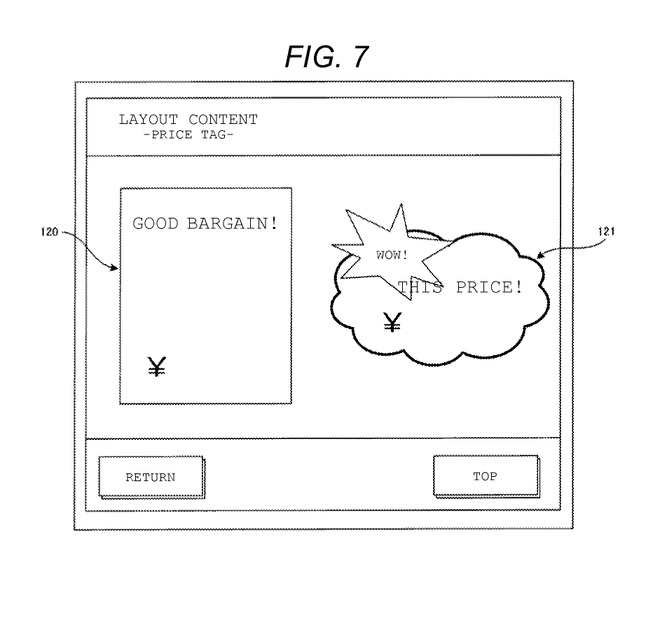

The control unit 30 instructs the control panel 35 to display a list of thumbnail images of layout contents capable of being provided (ACT006). The control unit 30 acquires one or a plurality of thumbnail images that are registered in the content DB 24 of the print server 11 through the communication unit 31 and causes the control panel 35 to display a list of the images. FIG. 7 illustrates an example of the screen at this time. The control unit 30 detects which one of thumbnail images 120 and 121 is selected (ACT007).

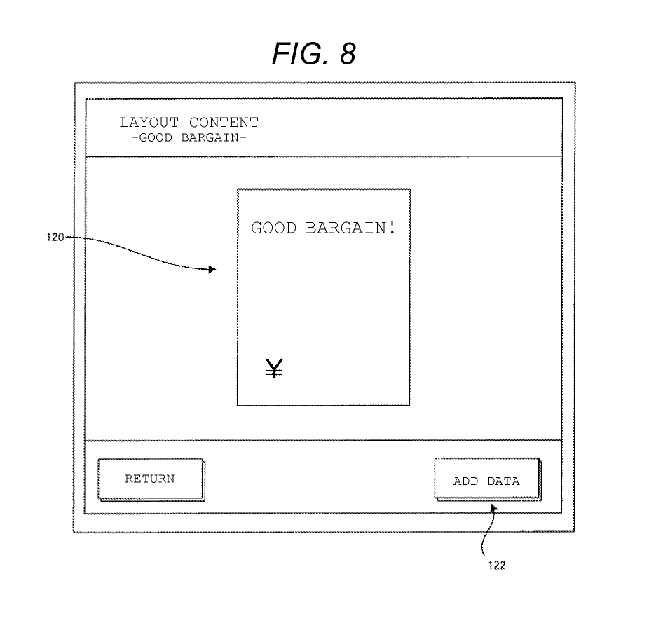

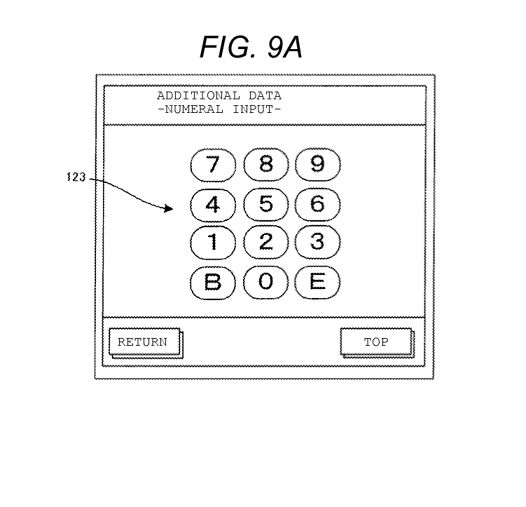

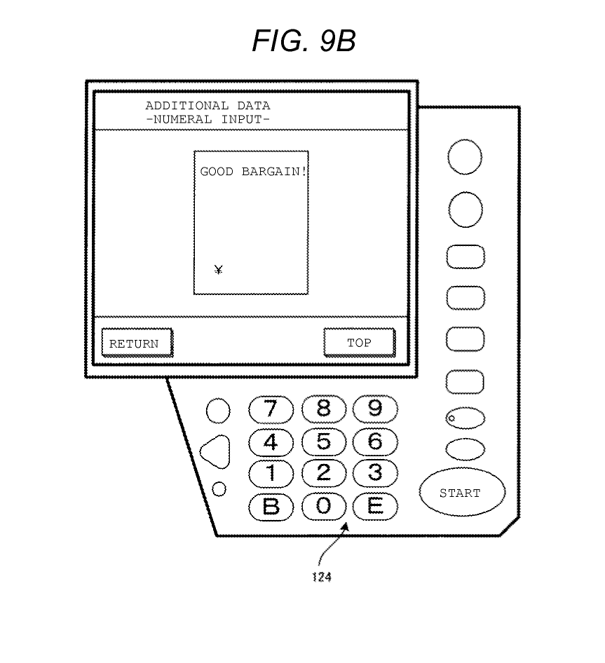

The control unit 30 performs a process of displaying a layout content selected by the user. FIG. 8 illustrates a display example. The control panel 35 displays the layout content 120, which is selected by the user, and a button 122 of “add data.” When the button 122 is selected by the user, the control unit 30 controls the control panel 35 to display a screen for inputting the additional data as illustrated in FIGS. 9A and 9B. An input unit for the additional data is a software keyboard 123 that receives an operation on a touch panel illustrated in FIG. 9A or a hardware keyboard 124 mounted on the control panel 35 illustrated in FIG. 9B.

The control unit 30 determines whether or not an input from various keyboards illustrated in FIGS. 9A and 9B is completed (ACT008). When the input is completed (ACT008, Yes), a process of integrating the layout content, which is selected by the user, with the input additional data is performed (ACT009). The operation of ACT009 will be described later in detail.

When the integration process is completed, the control unit 20 of the print server 11 generates an ID for the integrated image and registers the integrated image, as a content for performing the on-demand printing, in the content DB 24 (ACT010). The control unit 20 generates a thumbnail image of the integrated image (ACT011). The control unit 20 controls the HDD 53 of the print server 11 to store the respective pieces of image data (entity data) of the integrated image and the thumbnail image and registers the file name thereof in the content DB 24 in correlation with the generated ID.

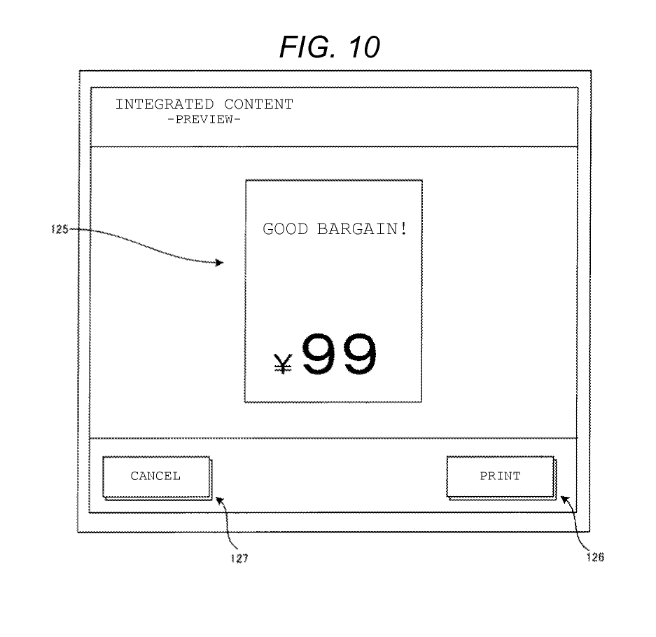

The control unit 30 of the MFP 10 acquires the integrated image from the print server 11 through the communication unit 31 and causes the control panel 35 to display the image (ACT012). A display example is shown in FIG. 10. The control panel 35 displays a integrated image 125 in response to an instruction of the control unit 30, and a button 126 of “print.” When the button 126 is selected (ACT013, Yes), the control unit 30 controls the image forming unit 32 to print the integrated image (ACT014). In addition, when a button 127 of “cancel” shown in FIG. 10 is selected (ACT013, No), the process returns to ACT004.

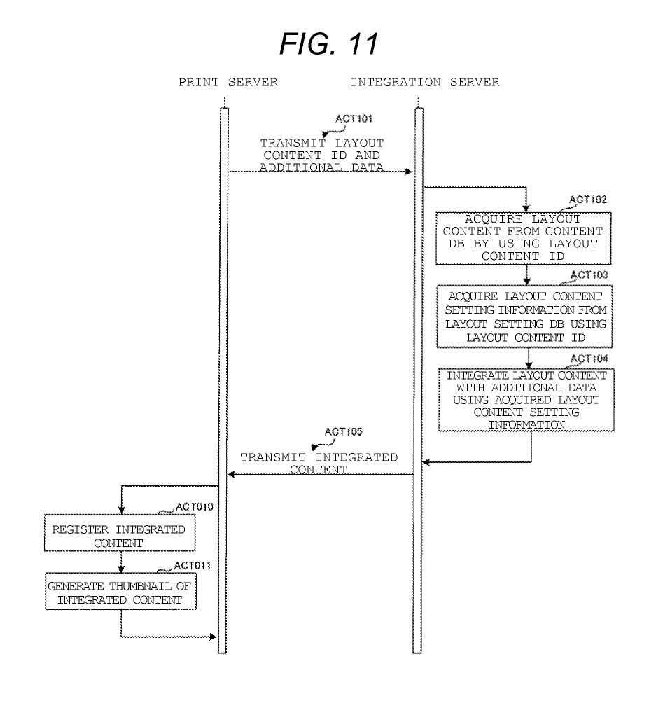

FIG. 11 is a flow chart illustrating the details of the integration process of ACT009. The integration process of ACT009 is mainly performed by the print server 11 and the integration server 13. The MFP 10 transmits data designated by the user and receives results of the integration.

When the selection of the layout content and the input of the additional data are completed (ACT008, Yes), the control unit 20 of the print server 11 receives input information (additional data) through the communication unit 23 from the MFP 10 and transmits a set of an ID of the layout content and the input information to the integration server 13 (ACT101). In addition, the ID is identification information of the layout content selected in ACT007 and is information capable of being acquired also in the print server 11.

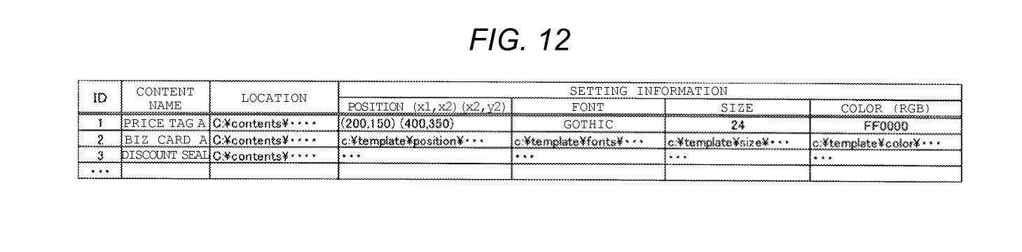

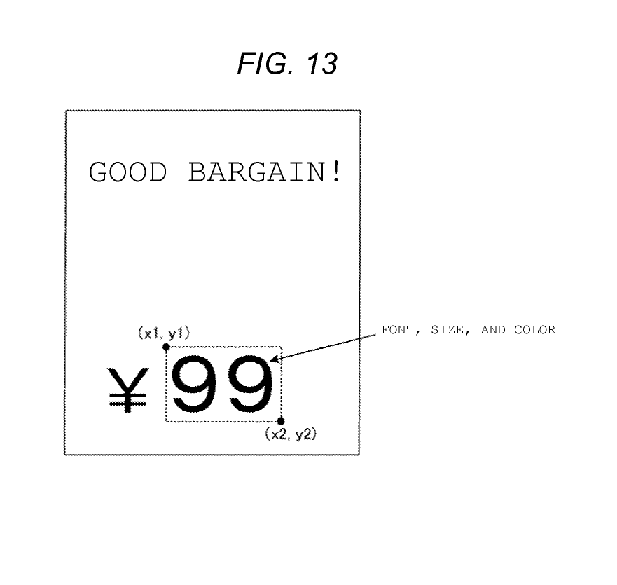

The control unit 40 of the integration server 13 acquires the layout content (image data) from the HDD 49 based on contents registered in the content DB 44, using the received layout content ID (ACT102). Further, the control unit 40 acquires layout content setting information from the layout setting DB 45 by using the received layout content ID (ACT103). FIG. 12 illustrates an example of the layout content setting information stored in the layout setting DB 45. The layout content setting information is correlated with an ID, a name of content (content name), a storage location of the layout content, and setting information. As illustrated in FIG. 13, the setting information defines at which location (upper left and lower right coordinate information) the additional data is to be integrated using which font, size, and color. In addition, when the additional data is one character string, such as a “price tag A”, as illustrated in this example, one for each of a font, font size, and color data to be used may be defined. However, when the additional data is configured with a plurality of character strings like a business card, the character strings may have different positions, fonts, sizes, and colors. When the additional data is configured with a plurality of character strings, pieces of data related to a position, a font, a size, and a color are defined by separate files as illustrated in a “business card tag A” of FIG. 12, and the file names thereof are registered in a DB. A data structure within each of the definition files of the position, the font, the size, and the color may have various modes depending on designs.

The control unit 40 performs a process of integrating the layout content with the additional data in response to the acquired layout content setting information (ACT104). That is, the control unit 40 generates an integrated image by fitting the additional data onto an image of the layout content so that the additional data has the position, font, size, and color indicated by the setting information. The control unit 40 transmits the integrated image generated through the communication unit 43 to the print server 11 (ACT105). Hereinafter, the print server 11 performs registration in the content DB 24 (ACT010) and generates the thumbnail image (ACT011) which are described also in the flow chart of FIG. 4.

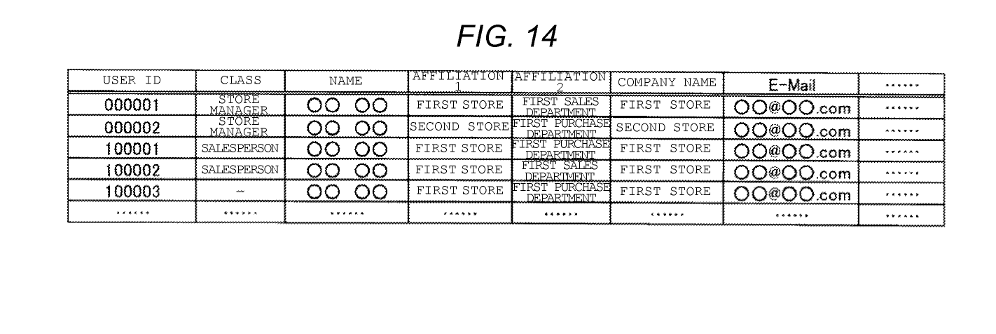

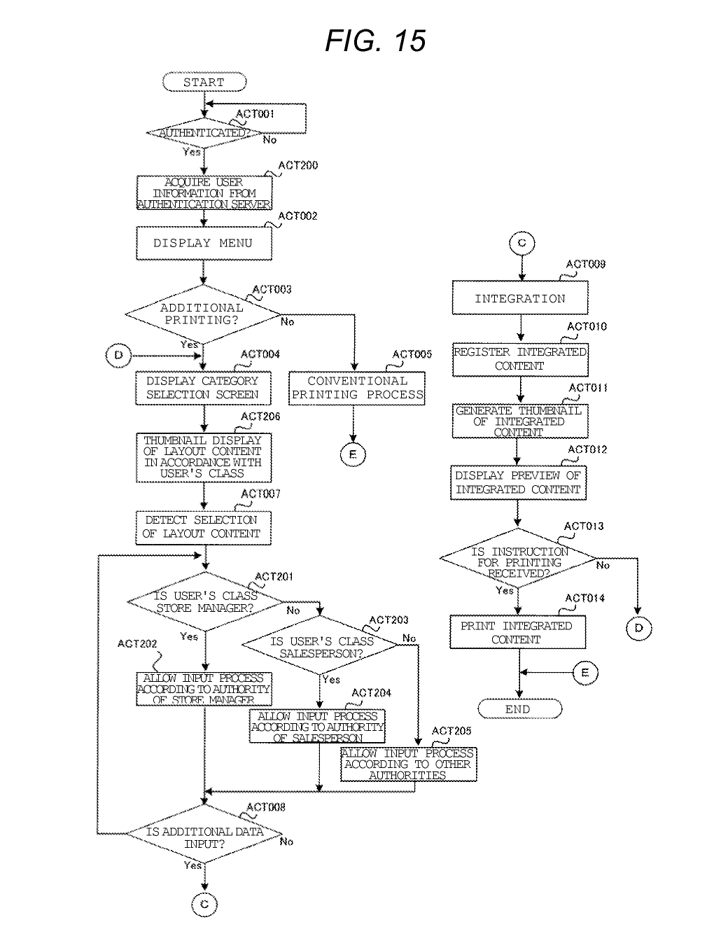

In addition, matters the user can add may vary depending on identification information and authority of the user operating the MFP 10 in inputting the additional data in ACT008 of FIG. 4, which will be described with reference to FIGS. 14 and 15. FIG. 14 illustrates an example of a data table in which identification information is associated with information related to a user. FIG. 15 is a flow chart for an operation of restricting an input of the additional data according to an authority is added to the process illustrated in FIG. 4.

First, the data table illustrated in FIG. 14 will be described. The data table is correlated with information such as identification information of a user (user ID), a rank of the user, name, affiliation 1 and affiliation 2 which represent affiliated departments, a company name, and an e-mail address. The storage location of the data table is assumed to be the authentication server 14 in this example, but is not limited thereto. For example, the data table may be stored in the additional data DB 46 of the integration server 13 or may be stored in the print server 11.

An operation illustrated in FIG. 15 will be described below. The control unit 30 of the MFP 10 completes user authentication (ACT001, Yes), and then receives information of the corresponding user (corresponding to one record of FIG. 14) from the authentication server 14 (ACT200). Thereafter, the printing system 1 performs ACT002 to ACT005 and ACT007 as described above. In this example, ACT206 is performed instead of ACT006, which will be described later.

In the user information acquired in ACT200, when the class is a store manager class (ACT201, Yes), the control unit 30 allows an input process in accordance with the authority of the store manager class (ACT202). When the class is not a store manager class (ACT201, No), the control unit 30 determines whether the class is a salesperson class (ACT203). When the class is a salesperson class (ACT203, Yes), an input process in accordance with the authority of the salesperson class is allowed (ACT204). When the class is not a salesperson class (ACT203, No), the control unit 30 allows an input process in accordance with other authorities (ACT205). The input process is performed, and the input is completed (ACT008, Yes), and then the process proceeds to ACT009. In addition, when the input is not completed (ACT008, No), the process returns to ACT201.

Various input processes based on authorities is available. For example, when a user is a store manager class, an input may be performed without restriction. On the other hand, when the user is a salesperson class, for example, only a price (numeral) up to five digits may be input, and users having other authorities are allowed to input up to four digits or are not allowed to input at all. In addition, the input processing based on the authorities may be performed on the server side by the control unit 20 of the print server 11.

In addition, a certain layout content may be available only for a person having an authority. For example, only a store manager class and a salesperson class may be able to use the layout contents 120 and 121 illustrated in FIG. 7, whereas other classes may use only the layout content 120. In this case, a thumbnail display in accordance with the user's class is performed (ACT206). During the thumbnail display, an unavailable layout content may have a mark to that effect attached thereto based on an instruction of the control unit 30, or the thumbnail display of an unavailable layout content may not be performed.

In addition, the class (authority information) is information obtained based on the user's identification information. That is, the input process according to the authorities and the thumbnail display in accordance with the authorities, which are described above, are performed based on the user's identification information.

It is possible to perform on-demand printing by integrating the selected layout content and the input information by a simple operation according to the above-described embodiment.

### Second Embodiment

In a second embodiment, a business card is printed by the printing system 1 described in the first embodiment. In addition, a system configuration, a hardware configuration, and a data configuration are the same as those in the first embodiment, and thus a description thereof will be omitted. In addition, reference numerals of units are replaced with those in the first embodiment.

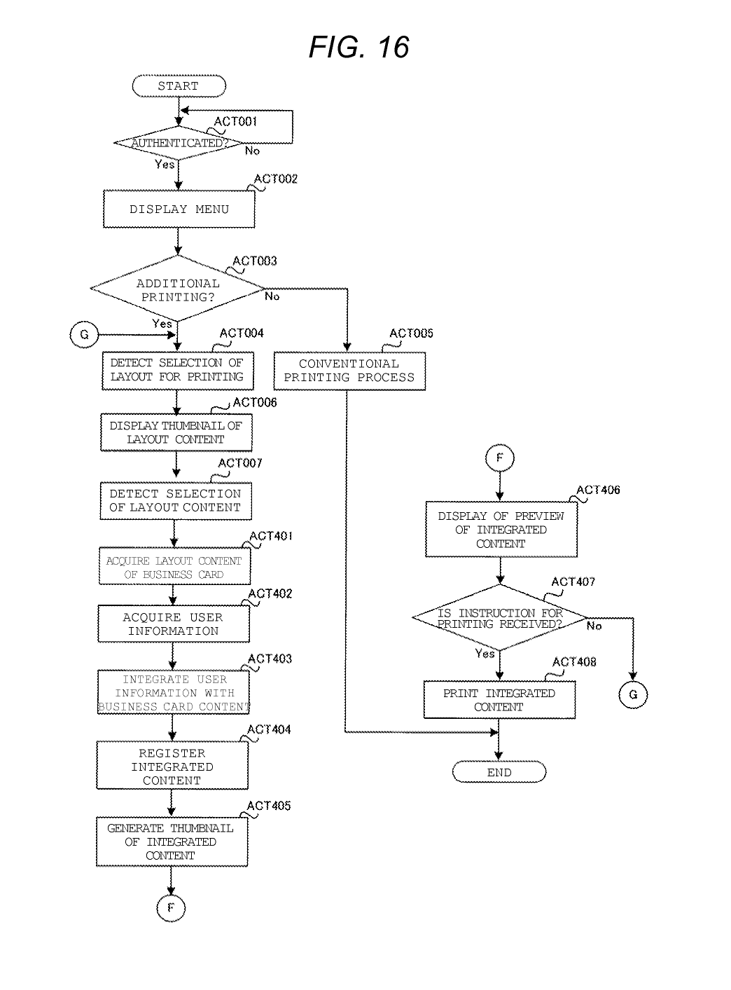

FIG. 16 is a flow chart illustrating an example of an operation of the printing system 1 according to the second embodiment. Operations of ACT001 to ACT007 are the same as those in the first embodiment. In ACT004, it is assumed that a button 114 (see FIG. 6) of “name card” is selected.

When a layout content is selected by a user (ACT007), the control unit 40 of the integration server 13 acquires the layout content (ACT401) and acquires user information (ACT402).

Details of the operations of ACT401 and ACT402 are as follows. The control unit 30 of an MFP 10 transmits an ID of the selected layout content and an authenticated user ID to the print server 11, and the control unit 20 of the print server 11 transmits the IDs to the integration server 13. The control unit 40 of the integration server 13 acquires the layout content associated with the layout content ID from the content DB 44. In addition, when the layout content ID is a value indicating a content for a business card, the control unit 40 acquires the corresponding user information (slightly additional data) from the authentication server 14 based on the user ID. The user information acquired herein is information corresponding to one record of a table illustrated in FIG. 14.

The control unit 40 performs a process of integrating the acquired user information with the layout content for a name card (ACT403). When the integration process is completed, the control unit 20 of the print server 11 performs a process of registering the integrated content as content for printing (ACT404). Here, the integrated content is registered in the content DB 24 in a similar manner to the first embodiment. The control unit 20 of the print server 11 generates a thumbnail image of the integrated image (ACT405).

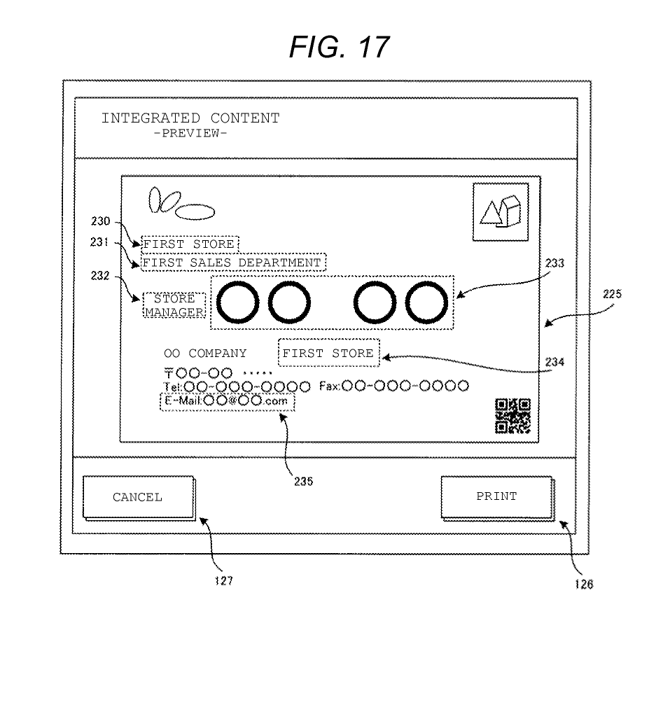

The control unit 30 of the MFP 10 acquires the generated integrated image and controls the control panel 35 to display a preview of the integrated image (ACT406). A display example is illustrated in FIG. 17. Pieces of character string information illustrated by dashed-line regions 230 to 235 of the integrated image 225 are additional data extracted from the user information illustrated in FIG. 14, and are pieces of information different from each other for individual users. Other patterns and character strings are data included within the layout content.

When a print button 126 is selected by the user (ACT407, Yes), the control unit 30 controls the image forming unit 32 to print the synthesized image (ACT408). When a cancel button 127 is selected (ACT407, No), the process returns to ACT004.

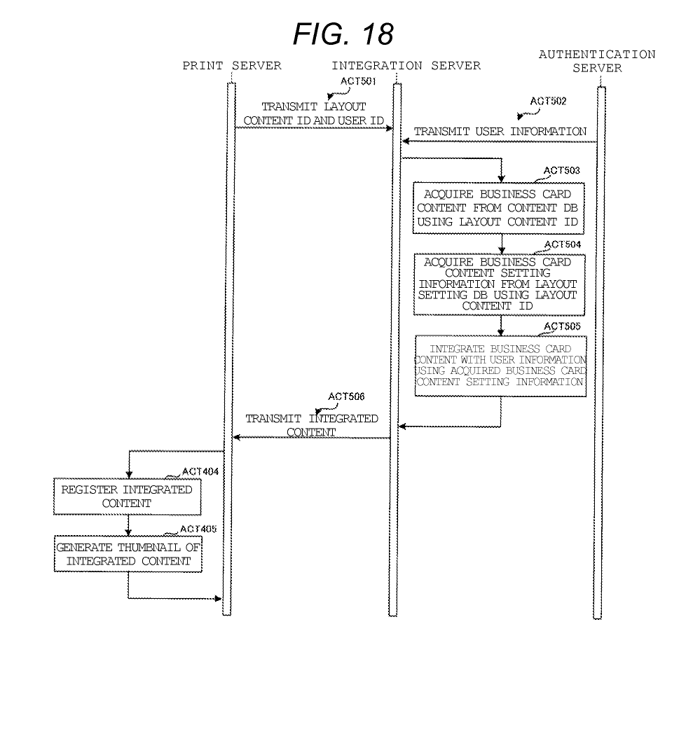

FIG. 18 is a flow chart illustrating operations carried out by the print server 11, the integration server 13, and the authentication server 14, related to a process of integrating the layout content and the additional data according to the second embodiment. The control unit 20 of the print server 11 controls communication unit 23 to transmit the layout content ID and the user ID to the integration server 13 (ACT501). The authentication server 14 transmits the user information to the integration server 13 in response to a request from the integration server 13 (ACT502). When the layout content ID and the user information are transmitted to the integration server 13, the control unit 40 of the integration server 13 searches the content DB 44 by using the layout content ID and acquires a layout content for a business card from the HDD 49 by using a file name to be obtained (ACT503). Further, the control unit 40 acquires layout content setting information from the layout setting DB 45 by using the layout content ID (ACT504). Here, a record of which a content name is a business card A is acquired (see FIG. 12). As described in the first embodiment, the layout content setting information defines an arrangement position of slightly additional data (upper left and lower right coordinate information) and a font, size, and color of a character. However, when the additional data is configured with a plurality of character strings as in this example, the pieces of data are defined within separate files.

The control unit 40 performs a process of integrating the layout content with the user information based on the acquired setting information (ACT505). Here, various pieces of information of the additional data (user information illustrated in FIG. 12 in this example) and the arrangement position thereof will be described with reference to FIG. 17. As illustrated in FIG. 17, affiliation 1 is disposed in a region 230, and affiliation 2 is disposed in a region 231. In addition, a class, a name, a company name, and an e-mail address are disposed in a region 232, a region 233, a region 234, and a region 235, respectively.

The control unit 40 controls the communication unit 43 to transmit the synthesized image to the print server 11 (ACT506). As described above with reference to FIG. 16, the print server 11 registers the received integrated image in the content DB 24 (ACT404) and generates a thumbnail image from the integrated image (ACT405).

With such a configuration, when a user performs on-demand printing, the user may integrate information added by the user with the preset content with a simple operation and may print the integrated image.

The configurations of the servers and devices within the above-described printing system 1 are not limited thereto. Various modifications are available depending on the processing performance of the servers. For example, one server having functions of the print server 11 and the integration server 13 may be provided, and functions of all the servers may be performed by the MFP 10. Alternatively, the above-described servers or a partial function of the MFP 10 may be provided as a control device or a control unit.

In the above-described embodiments, preset data (image and text) is used, and when there are additional data to be printed, only the additional data are input. User's operations only include selecting of the layout content and inputting of the additional data according to the above-described embodiments, and thus may be drastically reduced.

As described above, in the embodiments, a user's input operation may be reduced, and thus it is possible to easily perform printing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a main body housing an image forming unit; and
a control panel mounted on the main body and including a display unit and an operation unit, the display unit being configured to display a document template and the operation unit being configured to receive a user input related to an image to be added to the document template, wherein
the image forming unit is configured to form an image including the document template and the image added to the document template.

2. The image forming apparatus according to claim 1, further comprising:
an input unit configured to acquire identification information of a user; and
a control unit configured to obtain the identification information from the input unit, and limit users who can make inputs into the operation unit based on the acquired identification information.

3. The image forming apparatus according to claim 2, wherein
the control unit is further configured to obtain a category of the user associated with the identification information, and to limit user who can make inputs into the operation unit based on the category of the user.

4. The image forming apparatus according to claim 2, wherein
the control unit is further configured to determine one or more document templates available to the user based on the acquired identification information,
the display unit is further configured to display the available document templates, and
the operation unit is further configured to receive an input selecting a document template from the available document templates.

5. The image forming apparatus according to claim 1, further comprising:
an input unit configured to acquire identification information of a user; and
a control unit configured to obtain user information corresponding to the acquired identification information, wherein
the image formed by the image forming unit includes, in the document template, an image corresponding to the obtained user information.

6. The image forming apparatus according to claim 1, further comprising:
a control unit configured to obtain layout information indicating a layout of the image added to the document template.

7. The image forming apparatus according to claim 1, wherein
the display unit is further configured to display the image formed by the image forming unit.

8. An image forming system comprising:
an image forming section including:
a main body housing an image forming unit, and
a control panel mounted on the main body and including a display unit and an operation unit, the display unit being configured to display a document template and the operation unit being configured to receive a user input related to an image to be added to the document template; and
an integration section configured to generate an image including the document template and the image added to the document template, wherein
the image forming unit is configured to form the generated image.

9. The image forming system according to claim 8, wherein
the image forming section further includes
an input unit configured to acquire identification information of a user; and
a control unit configured to obtain the identification information from the input unit, and limit users who can make inputs into the operation unit based on the acquired identification information.

10. The image forming system according to claim 9, wherein
the control unit is further configured to obtain a category of the user associated with the identification information, and to limit user who can make inputs into the operation unit based on the category of the user.

11. The image forming system according to claim 9, wherein
the control unit is further configured to determine one or more document templates available to the user based on the acquired identification information,
the display unit is further configured to display the available document templates, and
the operation unit is further configured to receive an input selecting a document template from the available document templates.

12. The image forming system according to claim 8, wherein
the image forming section further includes
an input unit configured to acquire identification information of a user; and
a control unit configured to obtain user information corresponding to the acquired identification information, and
the image formed by the image forming unit includes, in the document template, an image corresponding to the obtained user information.

13. The image forming system according to claim 8, wherein
the image forming section further includes a control unit configured to obtain layout information indicating a layout of the image added to the document template.

14. The image forming system according to claim 8, wherein
the display unit is further configured to display the image formed by the image forming unit.

15. A method for forming an image using an image forming apparatus including a main body housing an image forming unit and a control panel mounted on the main body and including a display unit and an operation unit, the method comprising:
controlling the display unit to display a document template;
receiving, at the operation unit, the user input related to an image to be added to the document template;
generating an image by adding the image to the document template; and
controlling the image forming unit to form the generated image.

16. The method according to claim 15, further comprising:
acquiring identification information of a user; and
limiting users who can make inputs into the operation unit based on the acquired identification information.

17. The method according to claim 16, further comprising:
obtaining a category of the user associated with the acquired identification information, wherein
the limiting of the users is based on the category of the user.

18. The method according to claim 16, further comprising:
determining one or more document templates available to the user based on the acquired identification information;
controlling the display unit to display the available document templates; and
receiving an input selecting a document template from the available document templates.

19. The method according to claim 15, further comprising:
acquiring identification information of a user;
obtaining user information corresponding to the acquired identification information; and
adding an image corresponding to the obtained user information to the document template.

20. The method according to claim 15, further comprising:
obtaining layout information indicating a layout of the image added to the document template.
